(19) United States
(12) Patent Application Publication
(10) Pub. No.: US 2007/0288964 A1
(43) Pub. Date: Dec. 13, 2007

(54) Video recorder

(75) Inventor: Takeo Horiguchi, Yokohama-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/715,248

(22) Filed: Mar. 6, 2007

(30) Foreign Application Priority Data
Apr. 4, 2006 (JP) P2006-103072

(51) Int. Cl. G06F 3/00

(52) U.S. Cl. 725/46

(57) ABSTRACT

According to one embodiment, there is provided a video recorder including: a program information acquisition section that acquires program information; a storage that stores a program viewing history and a recording history; a recommended program determination section that determines a recommended program based on the program information, the program viewing history, and the recording history; a program reception section that receives the recommended program; a record/reproduce control section that records the recommended program automatically and reproduces the recorded recommended program; and an output section that automatically starts to output the recommended program at a turn on time when the video recorder is turned on.

### CROSS-REFERENCE TO RELATED APPLICATIONS

This application is based upon and claims the benefit of priority from Japanese Patent Application No. 2006-103072, filed Apr. 4, 2006, the entire contents of which are incorporated herein by reference.

### BACKGROUND

1. Field

One embodiment of the invention relates to a video recorder and in particular to a video storage that learns user's preference and selectively outputs a program highly matching the user's preference.

2. Description of the Related Art

Japanese Patent Application Publication (KOKAI) No. 2003-219287 known as a related art discloses a broadcasting receiver that references a viewing history of a user using the receiver and preference information and program attribute information and selectively outputs a program that the users want to view.

According to the broadcasting receiver, the viewing history containing the broadcasting date and time, the title, the genre, the content, performer information, etc., of each program viewed by the user and the preference information extracted from elements such as the genre, the content, obtained from the viewing history are recorded and are daily updated. Then, a user's desired program can be output by checking the program information at the time of viewing and program information of each program being recorded or already recorded.

According to the broadcasting receiver, the programs being recorded and already recorded can be considered as output candidates. However, the user needs to perform recording operation. Also, if a program highly matching the user's preference is an unrecorded program, the program is not considered as an output candidate. If the program being recorded is considered as an output candidate, the broadcasting receiver does not able to determine to reproduce the program from the beginning at the same time as recording (follow-up replay) or to output the program being broadcast at the time, according to the user's preference.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic drawing of a video recorder according to a first embodiment of the invention;

FIG. 2 is an exemplary block diagram to show the schematic configuration of the video recorder according to the first embodiment of the invention;

FIG. 3 is an exemplary schematic drawing to show the configuration of main unit software in the first embodiment of the invention;

FIG. 4 is an exemplary flowchart to show the operation of preference model creation processing according to the first embodiment of the invention;

FIG. 5 is an exemplary flowchart to show the operation for automatic recording processing according to the first embodiment of the invention;

FIG. 6 is an exemplary flowchart to show the operation of the video recorder according to the first embodiment of the invention;

FIG. 7 is an exemplary schematic drawing to show the configuration of video recorders and an external server according to a second embodiment of the invention;

FIG. 8 is an exemplary schematic drawing to show the configuration of main unit software according to the second embodiment of the invention;

FIG. 9 is an exemplary schematic drawing to show the configuration of server software according to the second embodiment of the invention;

FIG. 10 is an exemplary plan view to show the configuration of a remote control according to a third embodiment of the invention; and

FIG. 11 is an exemplary schematic drawing to show the configuration of main unit software according to the third embodiment of the invention.

### DETAILED DESCRIPTION

Various embodiments according to the invention will be described hereinafter with reference to the accompanying drawings. In general, according to one embodiment of the invention, there is provided a video recorder including: a program information acquisition section that acquires program information; a storage that stores a program viewing history and a recording history; a recommended program determination section that determines a recommended program based on the program information, the program viewing history, and the recording history; a program reception section that receives the recommended program; a record/reproduce control section that records the recommended program automatically and reproduces the recorded recommended program; and an output section that automatically starts to output the recommended program at a turn on time when the video recorder is turned on.

### First Embodiment

### (Configuration of Video Recorder)

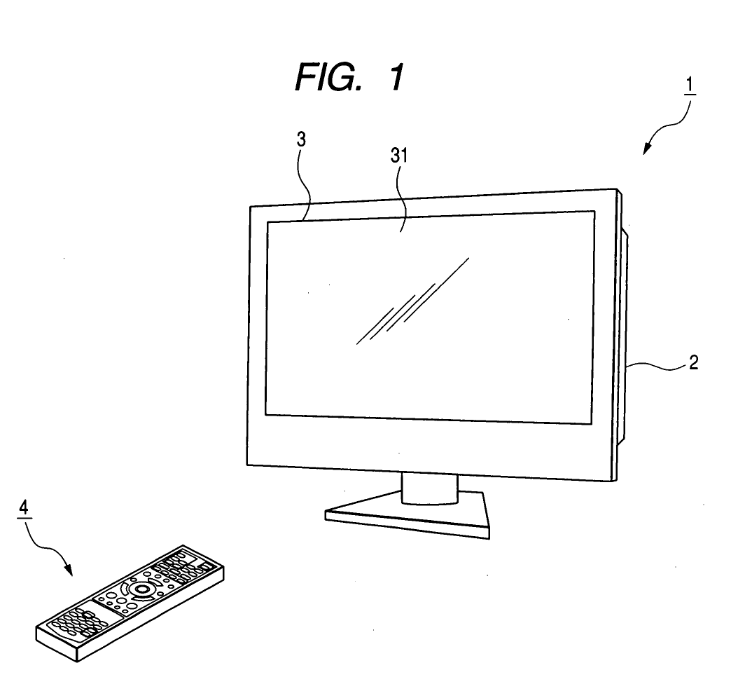

FIG. 1 is an exemplary schematic drawing of a video recorder according to a first embodiment of the invention.

A video recorder 1 includes: a main function section 2 having electronic parts such as a CPU (Central Processing Unit), an HDD (Hard Disk Drive); an image display section 3 having a display screen 31 for displaying an image, text, etc., output from the main function section 2, and a remote control 4 that acts on an interface (I/F) section of the main function section 2 for remotely controlling the video recorder 1.

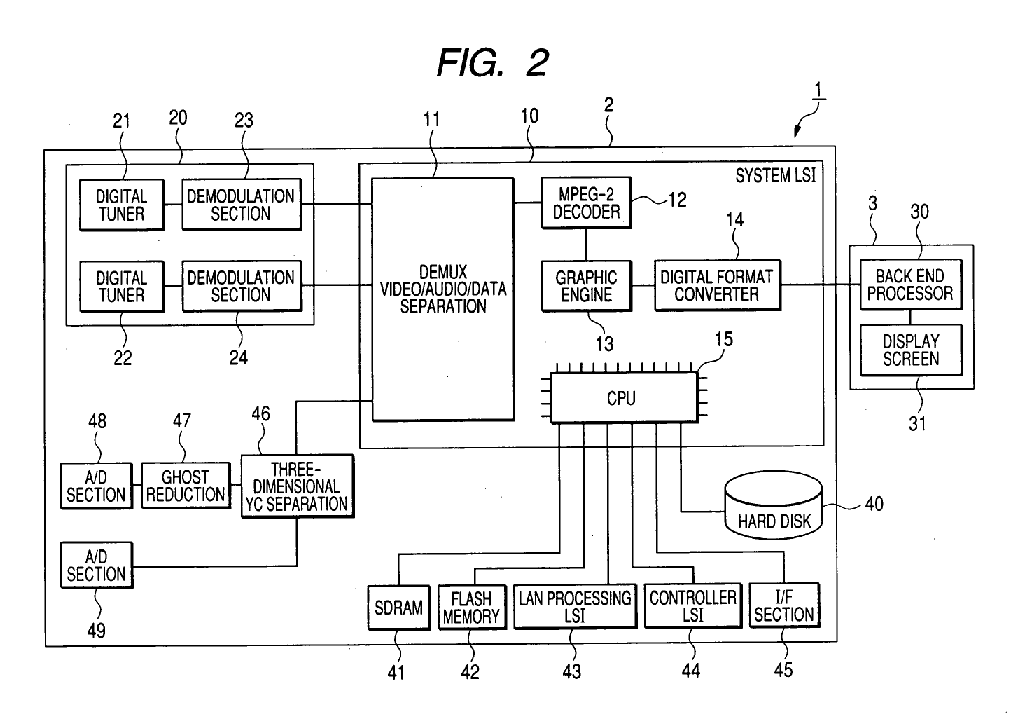

FIG. 2 is an exemplary block diagram to show the schematic configuration of the video recorder according to the first embodiment of the invention.

The main function section 2 includes a system LSI (Large-Scale Integration) 10 for processing digital video and a signal reception section 20 for receiving and demodulating a digital video signal. In addition to the function of receiving digital video, the main function section 2 has an A/D section 48 for receiving an output signal from an analog tuner, a ghost reduction 47 for reducing ghost occurring on the screen, three-dimensional YC separation for separating the video signal into a luminance signal and a chrominance signal, and an A/D section 49 for executing analog-digital conversion for connecting an external video device.

The system LSI 10 has DEMUX (DE-MUltipleXer) 11 for receiving a digital signal from the signal reception section 20 and an analog signal converted into a digital signal and separating the signal into video, audio, and program information, an MPEG-2 decoder 12 for decoding standard MPEG-2 used for digital broadcast, a DVD, etc., a graphic engine 13 for drawing the decoded image signal, and a digital format converter 14 for optimizing an output signal to the image display section 3.

The CPU 15 is connected to each section of the system LSI 10 for controlling the sections. From the CPU 15, a hard disk 40 for storing programs for video and for internal processing, SDRAM 41 for temporarily retaining data being processed by the CPU 15, flash memory 42 for copying and retaining data of external storage (not shown), etc., a LAN processing LSI 43 for conducting external communications through Ethernet®, etc., a controller LSI 44 for connecting to the external storage (not shown), and an I/F section 45 used for operation instruction reception of the remote control 4, connection to an external machine, and operation switches (not shown) included in the main function section 2 are connected.

The signal reception section 20 has a digital tuner 21 connected to an external antenna (not shown) for receiving terrestrial digital broadcasting, a demodulation section 23 for demodulating output from the digital tuner 21, a digital tuner 22 connected to an external antenna (not shown) for receiving BS and CS broadcasting, and a demodulation section 24 for demodulating output from the digital tuner 22.

The image display section 3 has the display screen 31 and a back end processor 30 for receiving output from the main function section 2, optimizing to the display screen 31, and making final image quality adjustment.

### (Configuration of Main Unit Software)

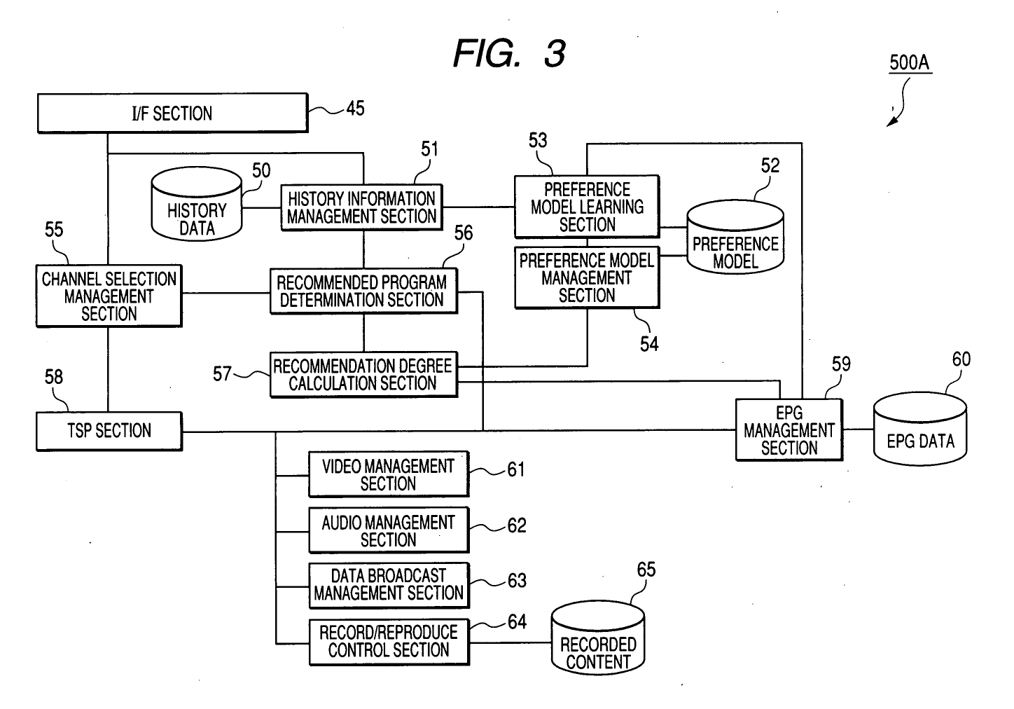

FIG. 3 is an exemplary schematic drawing to show the configuration of main unit software in the first embodiment of the invention.

Main unit software 500A for controlling the video recorder 1 is stored in the hard disk 40 shown in FIG. 2 and has the configuration as shown in FIG. 3. The operation of the main unit software 500A is controlled by the CPU 15 shown in FIG. 2. It is assumed that the I/F section 45 shown in FIG. 3 is an instruction input through the I/F section 45 shown in FIG. 2.

The main unit software 500A has history data 50 for storing program information of programs viewed by the user, a history information management section 51 for managing the history data 50, a preference model 52 for storing user's preference, a preference model learning section 53 for creating the preference model 52, a preference model management section 54 for managing the preference model 52, a channel selection management section 55 for selecting a broadcast station and transmitting a command to the digital tuner 21 or 22, a recommended program determination section 56 for referencing output from a recommendation degree calculation section 57 and determining a recommended program, the recommendation degree calculation section 57 for referencing the history data 50, the preference model 52, and EPG data 60 and calculating the recommendation degree of each program, a TSP (Transport Stream Processor) section 58 for performing TS (Transport Stream) separation processing such as filtering of a packet of the broadcast station selected by the channel selection management section 55, an EPG management section 59 for managing EPG (Electronic Program Guide) data, EPG data 60 for storing externally acquired EPG data, a video management section 61 for managing the video data provided by the TSP section 58, an audio management section 62 for managing audio data, a data broadcast management section 63 for managing data broadcast of program information, etc., a record/reproduce control section 64 for controlling recording of content and reproducing already recorded content, and recorded content 65 for storing recorded content.

### (Operation)

The operation of the video recorder 1 in the first embodiment of the invention will be discussed with reference to FIGS. 1 to 4.

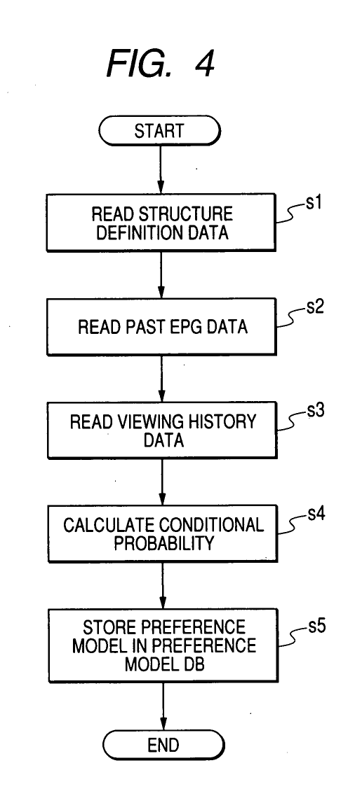

FIG. 4 is an exemplary flowchart to show the operation for preference model creation processing according to the first embodiment of the invention.

First, the preference model learning section 53 calls structure definition data based on a bayesian network which becomes a preference model template from the preference model 52 (s1). Next, the preference model learning section 53 accesses the EPG management section 59 and acquires EPG data in a past given time period from the EPG data 60 (s2). Next, the preference model learning section 53 accesses the history information management section 51 and acquires history data in a past given time period from the history data 50 (s3). Next, the preference model learning section 53 calculates a conditional probability value of each probability variable in the bayesian network based on the acquired data (s4), and stores a preference model provided by assigning the probability values to the structure definition data in the preference model 52 (s5).

It is assumed that preference model is created once a day and is updated every time. The user may set the creation interval of not only every other day, but also every other week, etc.

The system designer may set any desired value to find the conditional probability value.

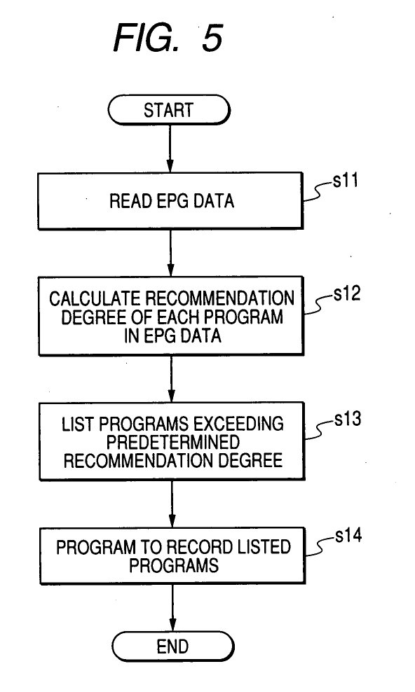

FIG. 5 is an exemplary flowchart to show the operation for automatic recording processing according to the first embodiment of the invention.

First, the recommendation degree calculation section 57 accesses the EPG management section 59 and acquires 24-hour EPG data from the EPG data 60 (s11). Next, the recommendation degree calculation section 57 accesses the preference model management section 54, calls the preference model from the preference model 52 and calculates the recommendation degree of each program in the EPG data (s12). Next, programs exceeding a predetermined recommendation degree are listed (s13). Next, the recommended program determination section 56 programs to record the listed programs. The record/reproduce control section 64 accepts the programming, instructs the channel selection management section 55 to make channel selection at the recording time, receives the corresponding video stream from the TSP section 58, and stores the video stream in the recorded content 65 (s14).

The operation of the automatic recording processing is executed every 24 hours. The EPG data read by the recommendation degree calculation section 57 is not limited to 24-hour EPG data. If the EPG data is read at intervals of other than 24 hours, it is assumed that the operation of the automatic recording processing is also executed based on the intervals.

The designer may design or the user may set the recommendation degree as the threshold value for listing the programs.

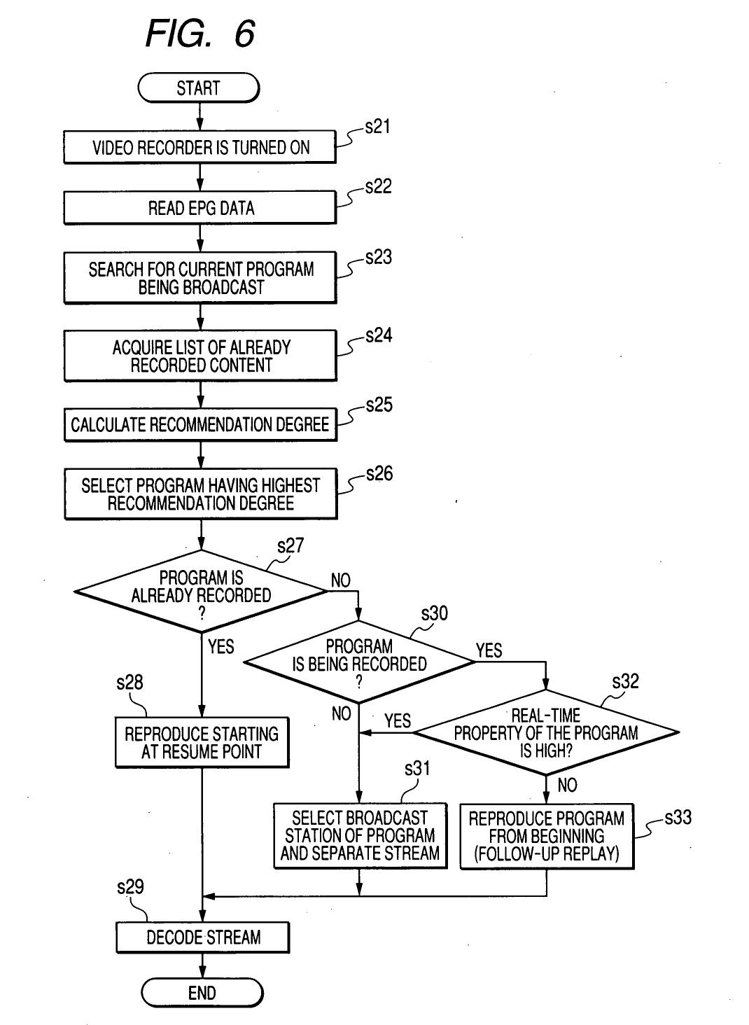

FIG. 6 is an exemplary flowchart to show the operation of the video recorder according to the first embodiment of the invention.

When the user turns on power of the video recorder 1 using the remote control 4 or a power button (not shown) installed on the main function section 2 (s21), the recommendation degree calculation section 57 accesses the EPG management section 59, reads EPG data from the EPG data 60 (s22), and searches for program information of the current program being broadcast (s23). The recommendation degree calculation section 57 accesses the record/reproduce control section 64 and acquires an already recorded content list from the recorded content 65 (s24). Next, the recommendation degree calculation section 57 calculates the recommendation degrees for the current TV programs being broadcast and all already recorded contents based on the preference model managed in the preference model management section 54 (s25). Next, the recommended program determination section 56 selects the program at the highest recommendation degree among the programs calculated by the recommendation degree calculation section 57 (s26).

Next, if the selected program is already recorded content (YES at s27), the content is reproduced starting at the previous reproduced point (resume point). Since no resume point is set for the program with no reproduce history, the program is reproduced from the beginning (s28).

If the selected program is not recorded although it is being broadcast (NO at s30), the channel selection management section 55 selects a channel of the selected program and the TSP section 58 performs TS separation processing such as filtering of a packet of the desired program (s31).

If the selected program is being broadcast and is being recorded (YES at s30), the recommended program determination section 56 determines whether or not real-time property of the program is high. If the real-time property of the program is high (YES at s32), the process goes to s31 and the user is allowed to view the program in real-time. If the real-time property of the program is low (NO at s32), the program is reproduced from the beginning (follow-up replay) (s33).

The video stream, the audio stream, and the like provided at s27 and the later steps are decoded by the MPEG-2 decoder 12 and are output as video through the circuit at the following stage (s29).

The recommended program determination section 56 determines the real-time property based on the genre of the program. For example, the genres of news, sports, etc., are defined as high real-time property and other genres are defined as low real-time property. The real-time property of each program may be learnt according to a learning method similar to a preference model.

### (Advantages of the First Embodiment)

According to the embodiment described above, the program highly matching the user's preference is recorded automatically, so that not only the programs broadcast at the turning on time, but also the already recorded programs are considered as selection candidates for display output. Therefore, it may be possible to obtain display output more faithfully reflecting the user's preference.

The video recorder 1 has the function of determining the real-time property of each program and can determine follow-up replay or usual viewing for viewing the program being recorded. Therefore, it may be possible to obtain display output more faithfully reflecting the user's preference.

According to the embodiment described above, the recommended program being recorded is reproduced from the beginning (follow-up replay), so that it may be possible to view the recommended program throughout the program along the time sequence. Also, if the program is not recorded, it can be viewed along the user's preference as much as possible.

### Second Embodiment

### (Configuration of Software)

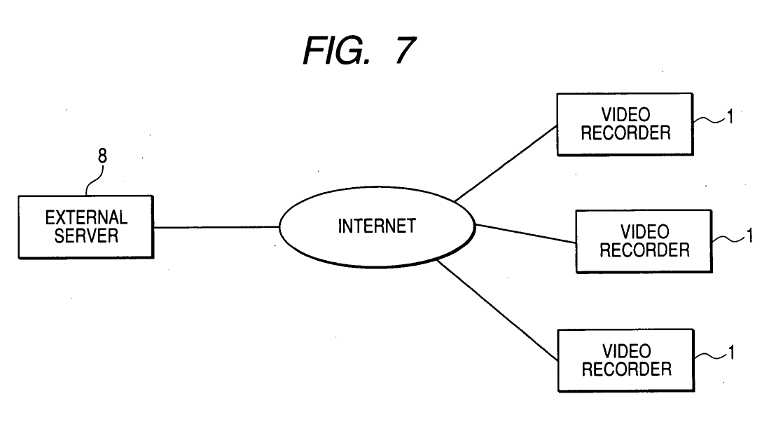

FIG. 7 is an exemplary schematic drawing to show the configuration of video recorders and an external server 8 according to a second embodiment of the invention. In the description to follow, components identical with or similar to those of the first embodiment are denoted by the same reference numerals.

The external server 8 is connected to the Internet and transfers information to and from a plurality of video recorders 1 conforming to TCP/IP.

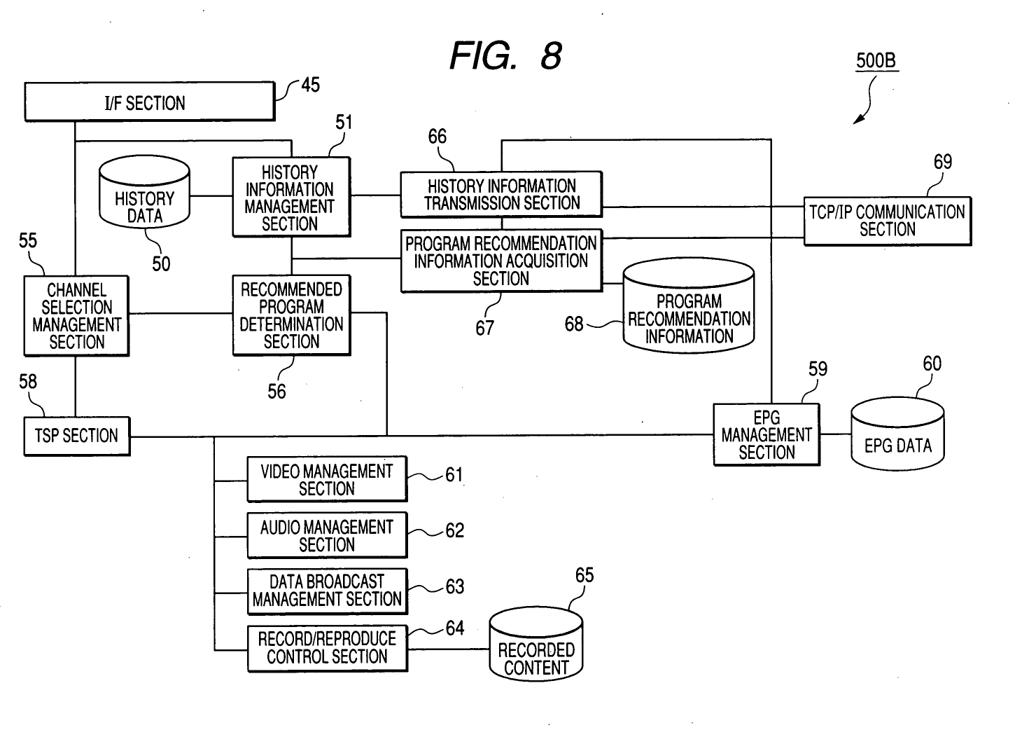

FIG. 8 is an exemplary schematic drawing to show the configuration of main unit software according to the second embodiment of the invention.

Main unit software 500B has: a history information transmission section 66 for transmitting an operation history of program viewing action, program recording action, program recording programming action, recorded content reproduce action, etc., of the user stored in history data 50 to the external server 8; a program recommendation information acquisition section 67 for acquiring the recommendation degrees of the programs being broadcast or scheduled to be broadcast and the recommendation degrees of recorded content from the external server 8; and a TCP/IP communication section 69 for connecting the sections to the Internet where the external server 8 exists.

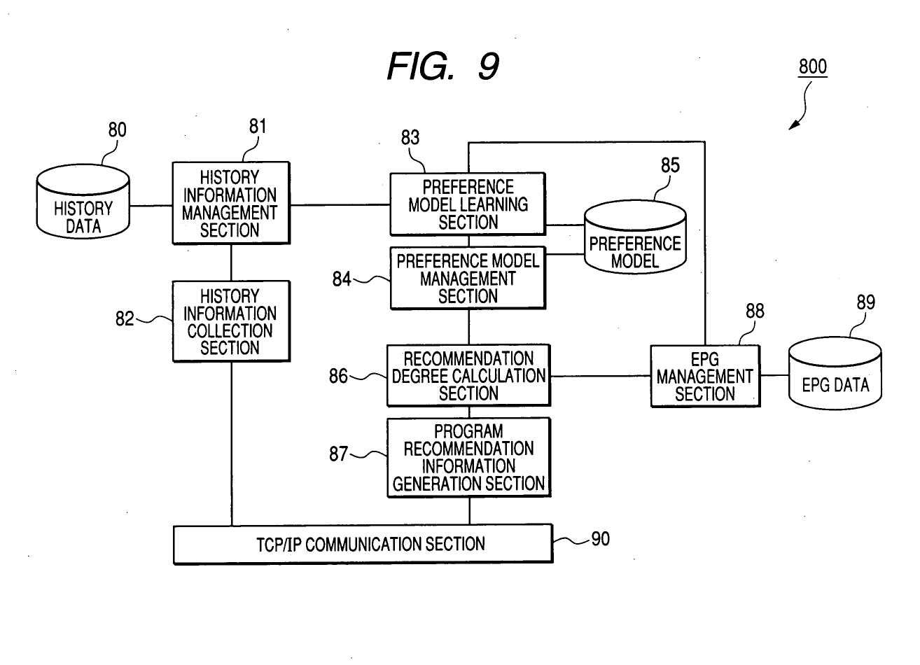

FIG. 9 is an exemplary schematic drawing to show the configuration of server software in the external server according to the second embodiment of the invention.

Server software 800 is connected to the Internet through a TCP/IP communication section 90. History information and program recommendation information requests are transmitted from the external video recorders 1.

The server software 800 has: a history information collection section 82 for collecting history information transmitted from the external video recorders 1; history data 80 for storing history information; a history information management section 81 for managing the history data 80; a preference model 85 for storing user's preference, a preference model learning section 83 for creating the preference model; a preference model management section 84 for managing the preference model 85; an EPG management section 88 for managing EPG data, EPG data 89 for storing externally acquired EPG data; a recommendation degree calculation section 86 for referencing the history data 80, the preference model 85, and the EPG data 89 and calculating the recommendation degree of each program; and a program recommendation information generation section 87 for collecting the probability values calculated by the recommendation degree calculation section 86 as program recommendation information and transmitting the program recommendation information to the video recorders 1.

### (Operation)

The operation of the video recorders 1 and the external server 8 in the second embodiment of the invention will be discussed with reference to FIGS. 7 to 9 and other accompanying drawings.

When the video recorder 1 is turned on, the history information transmission section 66 transmits history data to the external server 8. The history information collection section 82 of the external server 8 receives the history data and retains the history data in the history data 80 through the history information management section 81.

In the following steps, the external server 8 operates in a similar manner to that shown in the flowchart of FIG. 4. The preference model management section 84 calls structure definition data from the preference model 85 (s1), accesses the EPG management section 88 and calls EPG data in a past given time period from the EPG data 89 (s2), and accesses the history information management section 81 and calls and acquires history data from the history data 80 (s3). The recommendation degree calculation section 86 references the data and calculates a conditional probability value of each probability variable (s4), and stores a preference model provided by assigning the probability values to the structure definition data in the preference model 85 (s5).

The program recommendation information generation section 87 calls the preference model from the preference model 85, collects the preference model and program information as program recommendation information, and transmits the program recommendation information to the video recorder 1. The program recommendation information acquisition section 67 of the video recorder 1 acquires the program recommendation information and stores the program recommendation information in program recommendation information 68.

### (Advantages of the Second Embodiment)

According to the embodiment described above, the program highly matching the user's preference is calculated and is selected in the external server 8, so that the need for the mechanism for calculating and determining a recommended program in the video recorder 1 is eliminated and the configuration is simplified.

The external server 8 is updated without changing the video recorder 1, whereby the recommendation degree calculation section can be updated, so that the whole system can be easily customized and maintained still after the video recorder 1 is sold and is distributed.

The operation may be executed at a predetermined interval instead of being executed at the timing of turning on the power. To execute the operation at the predetermined interval, program recommendation information up to the timing of the next execution is acquired in advance and is stored in the program recommendation information 68. The program recommendation information 68 is referenced and the program to be output is determined at the same time when the video recorder 1 is turned on.

To execute the operation at the predetermined interval, the information is stored in the program recommendation information 68, so that the program can be output with no time loss of accessing the external server 8, etc., and without a delay at the turning on operation.

### Third Embodiment

### (Configuration of Remote Control)

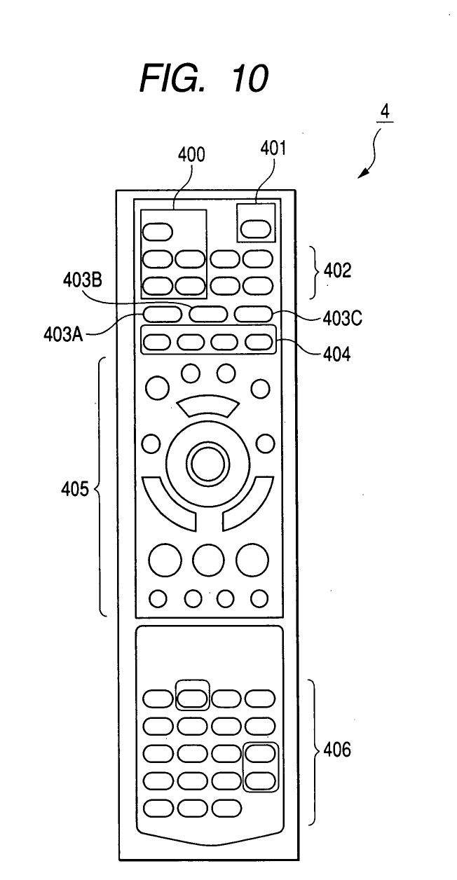

FIG. 10 is an exemplary plan view to show the configuration of a remote control according to a third embodiment of the invention.

A remote control 4 has: a TV function operation switch group 400 for enabling the user to turn on the TV, perform channel operation, etc.; a router video changeover switch 401 for switching between video display and router display; a display function operation switch 402 capable of switching a screen display mode; user recognition switches 403A to 403C capable of registering the viewing user; a media changeover switch 404 capable of switching display media; a record/reproduce apparatus switch group 405 for the user to perform operation of reproducing record video such as recorded content; and programming the apparatus to record a program, and a numeric value input switch group 406 for the user to enter a numeric value.

### (Configuration of Software)

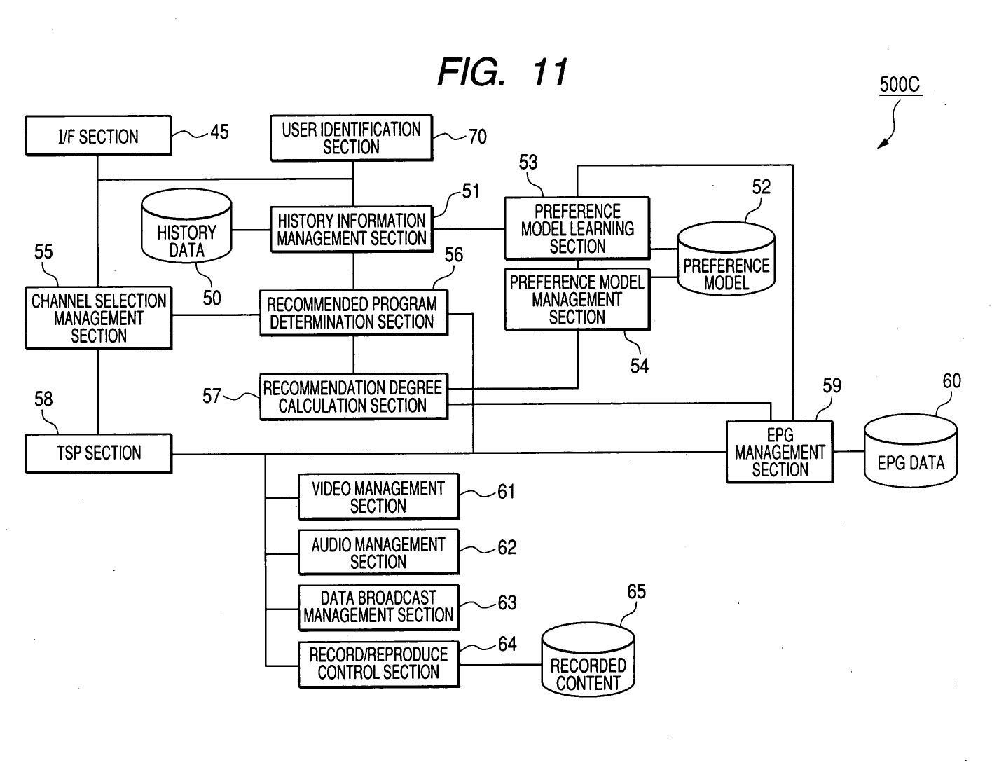

FIG. 11 is an exemplary schematic drawing to show the configuration of main unit software according to the third embodiment of the invention.

Main unit software 500C has a user identification section 70 that can identify the viewing user based on operation of the user recognition switches 403A to 403C of the remote control 4. History data 50 and a preference model 52 store history data and a preference model respectively for each user.

### (Operation)

The operation of a video recorder 1 in the third embodiment of the invention will be discussed with reference to FIGS. 10 and 11 and other accompanying drawings.

The user recognition switches 403A to 403C of the remote control 4 are toggle switches; once any of the user recognition switches 403A to 403C is pressed, the LED built in the switch goes on and a command based on the pressed one of the user recognition switches 403A to 403C is transmitted from the remote control 4 to the video recorder 1. For example, assuming that the switch 403A is for father, that the switch 403B is for mother, and that the switch 403C is for the eldest son, if the user recognition switch 403B is pressed, the video recorder 1 changes the state of the mother from “no viewing” to “current viewing” in the user identification section 70. If the user recognition switch 403B is once more pressed, the LED goes off and the state of the mother is changed from “current viewing” to “no viewing” in the user identification section 70.

The user identification section 70 switches the data used in the history data 50 and the preference model 52 to the data of the corresponding user based on the state of the user.

If a plurality of users are in “current viewing,” the history data and the preference models for the users are again calculated, thereby determining the recommended program. Priority may be defined for the users for determining the recommended program.

The history data 50 and the preference model 52 store not only the history data and the preference model for each user, but also general history data and general preference model used when the user operates the video recorder in a state in which the user is not identified. The general history data and the general preference model are created based on the history data and the preference model of all users.

### (Advantages of the Third Embodiment)

According to the embodiment described above, the user identification function is provided and the preference model is created for each user, so that it is made possible to determine the preference with higher accuracy for the currently viewing user.

The user recognition switches may be installed on the video recorder 1. The means is not limited to the user recognition switches 403A to 403C; person authentication with a camera, fingerprint authentication, palm vein authentication, etc., may be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video recorder comprising:
a program information acquisition section that acquires program information;
a storage that stores a program viewing history and a recording history;
a recommended program determination section that determines a recommended program based on the program information, the program viewing history, and the recording history;
a program reception section that receives the recommended program;
a record/reproduce control section that records the recommended program automatically and reproduces the recorded recommended program; and
an output section that automatically starts to output the recommended program at a turn on time when the video recorder is turned on.

2. The video recorder according to claim 1,
wherein when the record/reproduce control section is in process of recording the recommended program at the turn on time, the output section outputs the recommended program from the beginning of the recommended program, and
wherein when the recommended program is not recorded at the turn on time, the output section outputs the recommended program received by the program reception section.

3. The video recorder according to claim 1,
wherein the recommended program determination section further determines real-time property of the recommended program,
wherein when the record/reproduce control section is in process of recording the recommended program, and it is determined that the real-time property of the recommended program is low, at the turn on time, the output section outputs the recommended program from the beginning of the recommended program,
wherein when the recommended program is not recorded at the turn on time, the output section outputs the recommended program received by the program reception section.

4. The video recorder according to claim 1,
wherein when the record/reproduce control section has finished recording the recommended program at the turn on time, the record/reproduce control section reproduces the recommended program from a point to which the recommended program is reproduced previous time.

5. The video recorder according to claim 1,
wherein the storage stores the program view history and the program record history for each of users, and
wherein the recommended program determination section determines the recommended program based on the program view history, the program record history for each of the user in use and the program information.

6. The video recorder according to claim 1,
wherein the recommended program determination section determines the recommended program from among programs included in the program information and the recorded program by the record/reproduce control section.

7. A video recorder comprising:
a program information acquisition section that acquires program information;
a storage that stores a program viewing history and a recording history;
a communication section that transmits the program viewing history and the recording history to an external server;
a recommended program reception section that receives program recommendation information indicating a recommended program from the external server;
a program reception section that receives the recommended program;
a record/reproduce control section that records the recommended program automatically and reproduces the recorded recommended program; and
an output section that automatically starts to output the recommended program at a turn on time when the video recorder is turned on.

8. The video recorder according to claim 7,
wherein when the video recorder is turned on and the record/reproduce control section is in process of recording the recommended program, the output section outputs the recommended program from the beginning of the recommended program, and
wherein when the recommended program is not recorded at the turn on time, the output section outputs the recommended program received by the program reception section.

9. The video recorder according to claim 7,
wherein the program reception section further receives real-time property of the recommended program,
wherein when the record/reproduce control section is in process of recording the recommended program at the turn on time, and it is determined that the real-time property of the recommended program is low, the output section outputs the recommended program from the beginning of the recommended program,
wherein when the recommended program is not recorded at the turn on time, the output section outputs the recommended program received by the program reception section.
